(19) United States
(12) Patent Application Publication
(10) Pub. No.: US 2010/0063681 A1
(43) Pub. Date: Mar. 11, 2010

(54) METHOD AND ARRANGEMENT FOR THE STEERING OF A VEHICLE

(75) Inventors: Nico Correns, Weimar (DE); Enrico Geissler, Jena (DE); Michael Rode, Jena (DE); Christoph Nieten, Jena (DE); Tobias Neumann, Jena (DE); Ruediger Kuehnle, Buenos Aires (AR)

Correspondence Address: FISH & RICHARDSON PC, P.O. BOX 1022, MINNEAPOLIS, MN, 55440-1022, US

(73) Assignee: CARL ZEISS MICROIMAGING GMBH, Jena (DE)

(21) Appl. No.: 12/516,300

(22) PCT Filed: Nov. 20, 2007
(86) PCT No.: PCT/EP2007/010016

§ 371 Date: May 26, 2009

(30) Foreign Application Priority Data
Nov. 27, 2006 (DE) 102006055858.8

(51) Int. Cl. A01B 69/00; B62D 6/00; H04N 7/18

(52) U.S. Cl. 701/41; 348/120

(57) ABSTRACT

The invention relates to a method by which image data from the terrain lying in front of a vehicle (1) in the direction of travel are detected, and from which data steering commands to influence the direction and/or the speed of travel are generated. The invention relates further to an arrangement for steering an agricultural vehicle (1) according to this method. According to the invention, the problem is solved in that prominent objects (3) are selected by means of the image data, the distance between the vehicle (1) and the prominent objects (3) is determined, and the steering commands are generated from the image data which correspond to the objects and from the changes of distance between the vehicle (1) and the objects (3).

The invention concerns a process to capture image data for the terrain ahead of a vehicle in its direction of travel and to use that information to generate commands to modify the direction of travel and/or the speed of travel. Furthermore, the invention concerns a device to steer an agricultural vehicle based on this process.

The driver of the vehicle, particularly of an agricultural vehicle, such as a tractor, combine, or a field chopper, is normally responsible for a number of other tasks in addition to steering the vehicle, such as controlling the discharge arm, monitoring the level in the grain holding device, or controlling the adjustments of a field sprayer, a plow or a threshing apparatus.

Automatic guidance devices have been developed to aid the driver in the performance of these tasks. It is important here to keep to the track precisely, in order to avoid damaging the crop to be harvested, thus avoid a reduction of yield, and to overlap coverage optimally in order to save time and fuel, which would increase the economic efficiency of the agricultural production practices.

It is known to base the automatic guidance of a vehicle on a GPS device. A GPS receiver is located in the vehicle, and

software uses the dimensions of the field to compute an optimal route for the planned tasks, from which steering commands are generated and fed to the steering system.

The disadvantage of this method is the lack of precision, which does not meet the requirements of many applications. For example, in order to travel across a field, where the wheel tracks between the plant rows are no wider than the width of the tires and the track width of the vehicle, the maximum deviation from the track is 8 cm, if damage to plants is to be avoided. That cannot be achieved with a GPS device based purely on satellites.

Different GPS systems have been developed for such purposes to increase the precision. They supply the receiver in the vehicle not only with the satellite signal, but also with information from a stationary transmitter.

This permits an improvement in tracking precision to about ±5 cm. Such a system is described in US 2003/0208311 A1, for example.

U.S. Pat. No. 6,539,303 describes a further improvement by which two vehicles travelling in parallel are steered automatically.

However, both of these systems require a very precise knowledge of the position of obstacles or previous tracks. Such information is not available for the generation of windrows of plant material to be harvested.

Furthermore, adjustment must be made for any spatial drift of the system to be used that may be caused by the long time lag between seeding and harvest, for example.

Further developments of processes and devices for guiding vehicles are known in which information regarding the terrain surrounding the vehicle is used to generate steering commands, such as are described in U.S. Pat. No. 6,278,918 and U.S. Pat. No. 6,686,951.

Here, the terrain in front of the vehicle is monitored by means of a camera, and a down-stream image analysis uses various algorithms to evaluate the structures encountered. For example, windrows are differentiated from the mowed stubble field by the difference in color.

The problem arises here from the fact that the colors of the windrow and the background depend on external factors, such as moisture and dryness, such that the difference in color may be minimal in many instances. Likewise, the evaluation of the visual images depends on the available light. Shadows, particularly the shadow of the vehicle itself, may generate large variations in the signals to be processed and thus hinder the automatic interpretation significantly.

The article “Schwadabtastung mit Ultraschall” [Windrow Scanning with Ultrasound] in the journal Landtechnik, Volume 5/1993, page 266 ff, describes a process using several ultrasound sensors in rows parallel to the ground. Each sensor determines the distance to the ground and thus provides one observation for a height profile

to be derived from the distances observed by all sensors. Each scan provides two-dimensional information regarding the height profile. Repeated scans during movement of the vehicle will then yield three-dimensional information regarding the height profile.

This method will detect only relatively large structures, such as the height and width of a windrow on the scanned ground.

Other known devices use a stereo camera to derive an image, such as is described in EP 1 473 673, for example. The analysis of two images derived from differing angles from the vehicle will yield a three-dimensional profile of the surface, given that the two-dimensional images of identical objects are converted by the two images into a three-dimensional image.

The disadvantage here is that the positions of the two cameras must be known with precision and may not be moved on the vehicle.

An arrangement that uses a distance measuring device based on a laser scanner, as described in U.S. Pat. No. 6,389,785, scans a ground pattern vertical to the direction of travel point by point and estimates their distance. The measurements are combined to a three-dimensional profile while the vehicle is moving.

The scanner uses movable components to capture the image. The impacts and vibrations that are common on an agricultural vehicle

are thus likely to damage the measuring system and will also limit the useful life of the scanner.

Based on this state of the arts, the present invention has the objective of improving the processes for the automatic steering of a vehicle, specifically a vehicle used in agricultural production. The objective of the invention also includes the generation of a device that provides an efficiency improvement in the steering of an agricultural vehicle in field work.

The invention meets the objective by a process to steer a vehicle in which image data for the terrain ahead of the vehicle in the direction of travel are captured and used to derive steering commands to modify the direction of travel and/or the speed of travel such that significant object structures are selected from the image data, where the distance between the vehicle and the significant object structures is estimated repeatedly, and where the steering commands are generated from the image data related to the object structures and the changes in distance between the vehicle and the object structures.

Specific plants, rows of plants, furrows, windrows of material to be harvested, edges of roads or wheel tracks may be used as significant object structures, and the steering commands to modify the direction of travel are generated relative to such object structures.

In other words: The image data regarding the significant object structures and the changes in distance between the vehicle and the object structures related to such image data are used to derive steering commands that modify the steering of the vehicle and correct the direction of travel such that the wheels of the vehicle will automatically run in specified tracks, such as a precise alignment between plant rows without the assistance of the driver of the vehicle.

An advantageous embodiment of the process of the invention generates steering commands to modify the direction of travel or the speed of travel in order to avoid obstacles. This is used specifically to recognize objects that present a danger to the vehicle due to their size and nature. It is also feasible to detect moving objects in the direction of travel, such as other vehicles or persons and to generate steering commands to modify the direction of travel or the speed of travel and/or warning signals.

Another advantageous embodiment generates steering commands to modify the direction of travel or the speed of travel in order to control the separation and the alignment of the vehicle to be steered relative to other vehicles. For example, it is possible to synchronize the speed of travel or the direction of travel of a harvesting vehicle to the speed of travel or the direction of travel of a vehicle to transport the harvested product. Thus, the transfer of the harvested product from the harvesting vehicle to alternative transport vehicles may thus take place without an interruption of the harvesting process such that

the harvesting vehicle is optimally used. This mode of operation is particularly useful for moving choppers or in grain harvesting.

There are many tasks in agriculture that will have several machines on the same field at the same time. This may be a group of combines that travel at a slight offset to harvest grain, or it may be a harvester that empties into a trailer pulled by a tractor moving parallel to the harvester. In all such situations, the direction of travel and the speed of travel of the various machines to each other are of paramount importance to assure flawless performance.

Depending on the specific embodiment of the process of the invention, the image data may be acquired by infrared and/or visual light. This makes it feasible to use color analysis for spectral evaluation of the information in order to improve the recognition of windrows, for example, or to derive information about the density of a windrow. The guidance of the agricultural vehicle then reacts to the quantity and quality of the material to be harvested.

Another embodiment of the process of the invention is designed to issue acoustical warning signals simultaneously with the steering commands or independently, such that the vehicle operator may check the effectiveness of the automatic control and the corrective measures.

For an arrangement to steer an agricultural vehicle that includes
a motor to move the vehicle,
a steering device to determine the direction of travel,
a device to accelerate and decelerate the speed of travel,
an optical device to capture image data for the terrain directly ahead of the vehicle in the direction of travel, and with
a device to evaluate and process image data to generate steering commands for the steering device and/or for the device to accelerate and decelerate,
   the invention provides for
means to select image data for significant object structures, as well as
a device to measure distance for the periodic and repeated determination of the distance between the vehicle and such object structures, where
the device to analyze and process information is designed to generate steering commands based on the image data for the significant object structures and changes in distance between the vehicle and the object structures.

It is advantageous that the optical device include means to capture image data for object structures located ahead of the agricultural vehicle on a line that forms an angle with the direction of travel a α≠0°, preferably α≈90°.

Alternatively, the optical device includes means to capture image data for object structures located ahead of the agricultural vehicle on a plane that forms an angle with the direction of travel a α≠0°, preferably α≈90°.

The optical device to capture the image data includes individual optical sensors, lines of optical sensors and/or arrays of optical sensors. At least one of the sensors is embodied as a phase-sensitive sensor and is designed to be used to capture changes in distance data.

In this regard, it is advantageous to use a time-of-flight camera as the optical device. Whereas a conventional camera includes optical sensors that capture merely the brightness of image points, a time-of-flight camera has phase-sensitive sensors in lieu of or in addition to such sensors, which measure the time-of-flight of the light rays transmitting the image data in addition to its brightness, which facilitates measurements of distances. This relies on a separate modulated light source to illuminate the objects for which the distance is to be measured. Thus, a time-of-flight camera provides not only image data of objects, but also data regarding the distance to such objects.

When a time-of-flight camera is used, the terrain ahead of the vehicle is illuminated by a light source that is most advantageously integrated into the time-of-flight camera, and that will be modulated by a sine curve with a frequency f. The light ray moving at the speed of light c cycles at 1/f. The distance z to a selected illuminated object or an illuminated object structure is computed from the measurement of the phase shift during the time-of-flight of the light ray in accordance with the function

$$z = \frac{c}{2 f} * \frac{ϕ}{2 π}$$

where c is the speed of light, f is the modulation frequency and φ is the phase shift. Thus, the distance is determined from the phase shift φ.

This distance measurement method, which is also known as the “time-of-flight” approach, is described in detail, for example, in the journal “Elektronik,” WEK Fachzeitschriften-Verlag GmbH, 2000, Volume 12, in the article “Photomischdetektor erfaβt 3D-Bilder” [Photonic Mixer Device Captures 3-D Images]. Another description is found in the dissertation “Untersuchung and Entwicklung von modulationslaufzeitbasierten 3D-Sichtsystemen” [Analysis and Development of Modulation Time-of-Flight Based 3D Image Systems], submitted by Horst G. Heinold, Department of Electrical Engineering and Computer Science of the University Siegen. Thus, there is no need to present a detailed description at this point.

The invention is designed to yield an image for a windrow, for example, with a resolution of roughly 10 cm to 20 cm. However, for image data of plant rows, the device is advantageously embodied for a resolution of 5 cm to 10 cm.

It is advantageous to include cylindrical lenses or prisms upstream of the optical device in order to obtain a difference in the optical resolution in the image data across the field of view. As such, the cylindrical lenses

or prisms are designed such that certain sensor segments of the optical device capture image data of the terrain in front of the vehicle with a higher resolution than the other sensor segments.

The invention is explained below by reference to an embodiment example. The associated drawings show:

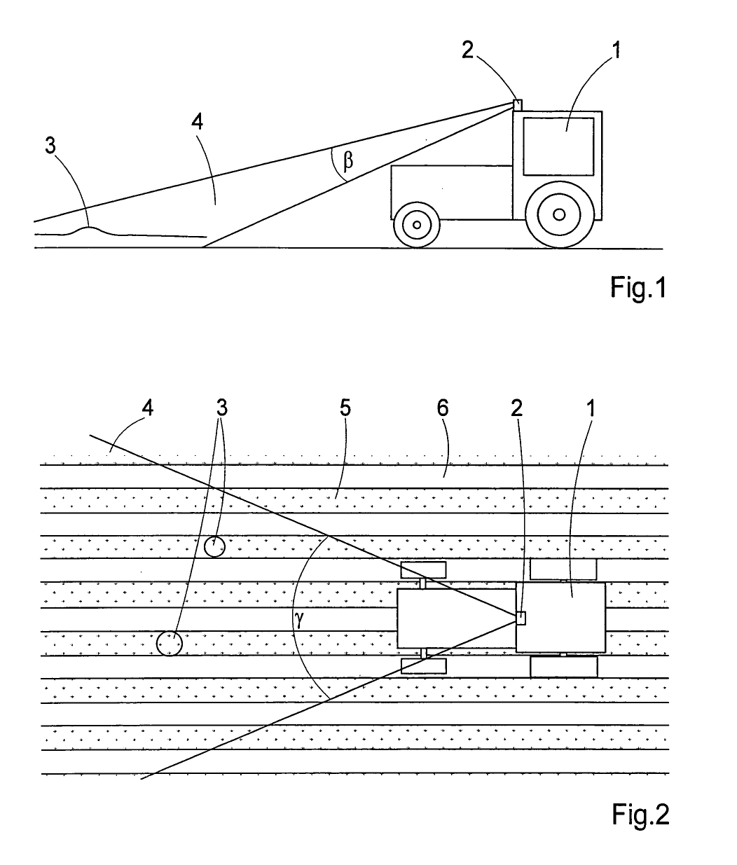

FIG. 1 a generalized side view of an agricultural vehicle on a planted field,

FIG. 2 the agricultural vehicle of FIG. 1 in a top view,

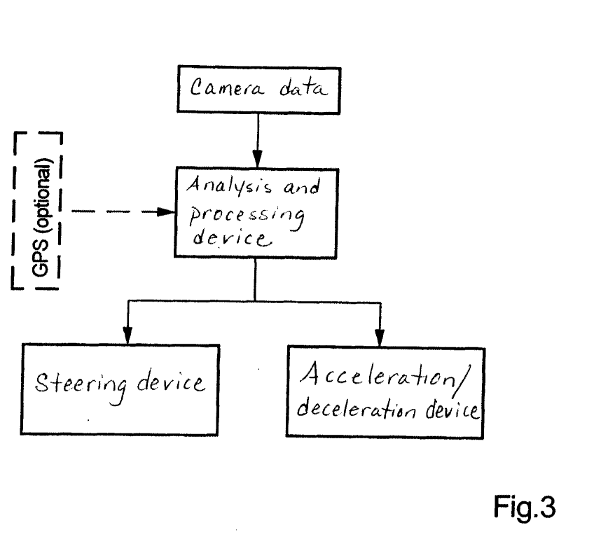

FIG. 3 a schematic of the signal transmission in the capture of image and distance data and the implementation of steering commands.

Agricultural vehicle 1 in FIG. 1 includes the following features, which are not shown in detail in the drawing:
a motor for propulsion,
a steering device to determine the direction of travel,
a device to accelerate and decelerate the speed of travel,
time-of-flight camera 2 designed to capture image data of significant object structures 3 located ahead of the vehicle in the direction of travel, as well as for the periodic and repeated determination of the distance between vehicle 1 and object structures 3, and
an analysis and processing device to generate steering commands for the steering device and for
the acceleration and deceleration device based on the image data and changes in distance.

As FIG. 1 shows, time-of-flight camera 2 has a scanning range 4 with a scanning angle β of about 15° to 40°. The size of scanning angle β depends on the intended use of agricultural vehicle 1 and is pre-specified by specific measures. For example, a scanning angle β of about 15° is sufficient, if agricultural vehicle 1 is used to harvest maize, whereas a wider scanning angle β would be desirable for movement along plant rows in order to recognize a divergence in the rows.

FIG. 2 shows a top view of the depiction of FIG. 1, which shows the lateral scanning angle γ of scanning range 4 of time-of-flight camera 2, which may range from 40° to 140°, for example. The size of scanning angle γ is also a function of the use of agricultural vehicle 1 and will be pre-specified by specific measures. For example, a scanning angle γ of 40° suffices for the recognition of windrows, whereas an agricultural vehicle 1 embodied as a combine requires a scanning angle γ wide enough to encompass the entire head of the combine.

Time-of-flight camera 2 contains an array of sensors, of which one, preferably several, most preferably all, is/are embodied with phase sensitivity and yield/s data on brightness as well as data on distance and where the signal inputs are linked to

the analysis and processing device, which is preferably housed within vehicle 1.

During operation of the device, time-of-flight camera 2 scans the terrain ahead of the vehicle in the direction of travel and transmits the thus obtained image data, depending on the sensor placement, as a one-dimensional or two-dimensional brightness scan of object structures 3 to the analysis and processing device.

As vehicle 1 continues to move and depending on the speed of movement, distance a between time-of-flight camera 2 or vehicle 1 and object structures 3 captured by time-of-flight camera 2 in its scanning range 4 continues to change.

Thus, the phase-sensitive sensors, using the “time-of-flight” approach, obtain data regarding distance a to the object structures in addition to the brightness values. These data are continually updated in the frequency prescribed by a timing generator that is preferably integrated into time-of-flight camera 2, thus providing a continuous three-dimensional depiction of the terrain ahead of vehicle 1 in the analysis and processing device. It is obvious that the frequency per unit of time is much higher than the distance traveled by vehicle 1 during that unit of time.

Phase-sensitive sensors are designed to obtain data regarding distances a, where these sensors are either arrayed in a line or on a plane such that image data

regarding several object structures positioned on a line or image data regarding several object structures on a plane may be obtained.

The three-dimensional image of the terrain ahead of vehicle 1 is evaluated continuously in order to track the significant object structures 3 from one image to the next. Depending on the application of the device described in the invention, such object structures 3 may consist of windrows, plant rows, cutting edges in grain harvest, areas with bent-over grain plants or rows of maize or soybeans. For example, FIG. 2 depicts plant rows 5, which extend parallel to the direction of movement of the vehicle and which are separated by furrows that serve as wheel tracks 6.

The continuous comparison of image data between images by means of the analysis and processing device provides data not only regarding the changes in distance, but also regarding changes in the position of vehicle 1 relative to object structures 3, thus deriving correction in steering commands for the steering device and the acceleration/deceleration device, which are transmitted to the latter and thus modify the direction of movement and the speed of movement of vehicle 1.

In a further embodiment of the device of the invention, the analysis and processing device is also designed to analyze the colors of the three-dimensional image, such that object structures 3 can be discerned not only based on their size or shape, but also based on their peculiar colors.

Thus, for example, it is possible to distinguish plant rows 5 clearly from wheel tracks 6 based on the data obtained. This results in a particularly high level of precision of the corrections in steering commands regarding the direction of movement of vehicle 1.

Other embodiments are also conceivable, such as an evaluation of the three-dimensional image with respect to a possible inclination of vehicle 1 due to uneven terrain.

It is also conceivable to augment the data provided to the analysis and processing device with data from a GPS system or a differential GPS system, which facilitates a further improvement in precision.

FIG. 3 shows the schematics of the device of the invention, which is self-explanatory given the labels and the signal flows as marked by arrows.

In contrast to the processes generally known from the state of the arts, where a scanning optical system generates a three-dimensional depiction of the terrain ahead of the vehicle, the process and device of the invention omit the scanning optical system. This makes it possible to capture several two-dimensional image data scans at the same time in parallel and to derive the three-dimensional depiction simultaneously, unlike what is provided by the state of the arts.

The process of the invention, in particular the embodiment shown as an example, may furthermore be used to detect obstacles in the scanning range ahead of the vehicle. Given that the system generates a three-dimensional depiction of the terrain, it is capable of recognizing objects that are a danger to the vehicle due to their size, such as large rocks, trees and other vehicles crossing the path of the vehicle unexpectedly.

Moreover, relative speeds can be determined with great precision from the image and distance data obtained. In particular, regarding the movement of agricultural machinery relative to an obstacle (such as another agricultural machine) in the direction of travel, image data generation based on the time-of-flight approach has the advantage of providing specific data regarding distances, whereas the conventional processes can generate data on distances only from a comparison of the size changes in the visual image.

The three-dimensional depiction of the terrain ahead of the agricultural vehicle can be used, for example, to make adjustments in the machinery connected to the vehicle based on the local topography. For example, it is feasible to adjust the cutting height of a combine automatically to avoid contact with the ground or a low obstacle and thus avoid damages. It is feasible to adjust the cutting height to an optimal level at all times.

The invention also includes embodiments where the time-of-flight camera is directed such that a three-dimensional depiction not only of the terrain in the direction of travel, but also of terrain behind the vehicle or at right angles to the direction of travel. Thus, for example, an adjacent vehicle can be monitored easily with regard to its location, separation, and/or relative speed and thus generate an adjustment in the speed of travel and direction of travel of the vehicle being controlled.

### LIST OF REFERENCE NUMBERS

1 Vehicle
2 Time-of-travel camera
3 Object structure
4 Scanning range
5 Plant row
6 Wheel track
a Distance
f Frequency

1. A process,
comprising:
selecting significant object structures based on image data for terrain ahead of the vehicle in a direction of travel of the vehicle,
determining a distance between the vehicle and the significant object structures repeatedly, and
generating steering commands based on the image data regarding the significant object structures and changes in distance between the vehicle and the significant object structures to modify the direction of travel of the vehicle and/or the speed of travel of the vehicle.

2. The process of claim 1, wherein certain plants, plant rows, furrows, windrows of material to be harvested, edges of roads or wheel tracks are used as the significant object structures.

3. The process of claim 1, wherein steering commands are generated to modify the direction of travel and tracking relative to the significant object structures.

4. The process of one of claims 1, wherein steering commands are generated to modify the direction of travel or the speed of travel to avoid the significant object structures.

5. The process of claim 1, wherein steering commands are generated to modify the speed of travel or the direction of travel in order to synchronize to a speed of travel or a direction of travel of at least one other vehicle.

6. The process of claim 1, wherein steering commands are generated to modify the speed of travel in order to adjust and/or maintain a constant output of agricultural machinery linked to the vehicle.

7. The process of claim 1, wherein the image data are procured with infrared light and/or visual light.

8. The process of one of claim 1, wherein the process is for the steering of an agricultural vehicle linked to harvesting equipment, and the steering commands are generated as a function of the quantity and quality of harvested material.

9. A system, comprising:
a motor configured to propel an agricultural vehicle,
a steering device configured to modify a direction of travel of the agricultural vehicle,
an acceleration/deceleration device configured to modify a speed of travel of the agricultural vehicle,
an optical device to capture image data for terrain ahead of the agricultural vehicle in the direction of travel of the agricultural vehicle, and
an analysis and processing device configured to generate steering commands from the image data for the steering device, for the acceleration/deceleration device, and/or for implements linked to agricultural vehicle,
a device configured to capture image data for significant object structures in the terrain
a distance measuring device for the periodic repeated determination of a distance between the agricultural vehicle and the significant object structures, wherein
the analysis and processing device is designed to generate the steering commands from the image data for the significant object structures and from changes in a distance between the agricultural vehicle and the significant object structures.

10. The system of claim 9, wherein the optical device comprises a device configured to capture image data for object structures ahead of the agricultural vehicle in a line that forms an angle with the direction of travel, and the angle is not equal to zero.

11. The system of claim 10, wherein the optical device comprises a device to capture image data for object structures ahead of the agricultural vehicle on a plane that forms an angle with the direction of travel, and the angle is not equal to zero.

12. The system of claim 9, wherein the optical device to capture image data comprises individual optical sensors, lines of optical sensors, and/or arrays of optical sensors.

13. The system of claim 13, wherein at least one of the sensors is a phase-sensitive sensor designed to capture changes in distances.

14. The system of claim 9, wherein the optical device to capture image data is attached to the agricultural vehicle and is fixed in position during travel of the agricultural vehicle.

15. The system of claim 9, wherein the optical device includes cylindrical lenses or prisms to provide unequal resolution in the capture of image data.

16. The system of claim 16, wherein the cylindrical lenses or prisms are embodied such that certain sensor segments of the optical device capture image data for the terrain ahead of the vehicle with a higher resolution than for other sensor segments.

17. The system of claim 10, wherein the angle is approximately 90°.

18. The system of claim 11, wherein the angle is approximately 90°.
